(19) United States
(12) Patent Application Publication
(10) Pub. No.: US 2009/0024798 A1
(43) Pub. Date: Jan. 22, 2009

(54) Storing Data

(75) Inventor: Alban Kit Kupar War Lyndem, Bangalore Karnataka (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P., Houston, TX (US)

(21) Appl. No.: 12/174,284

(22) Filed: Jul. 16, 2008

(30) Foreign Application Priority Data
Jul. 16, 2007 (IN) 1523/CHE/2007

(51) Int. Cl. G06F 12/16; G06F 12/08

(52) U.S. Cl. 711/129; 711/161; 711/206; 711/E12.059; 711/E12.023

(57) ABSTRACT

The invention provides a method of storing data in a computing device, the method including the steps of creating a memory file system in non-pageable kernel memory of the computing device, writing data to the memory file system and transferring the written data to a pageable memory space allocated to a user process running on the computing device. An advantage of such a design is that, initially, the data of the memory based file system can be kept in the non-pageable kernel memory, minimising the need to perform context switches. However, the data can be transferred to pageable memory when necessary, such that the amount of kernel memory used by the file system can be minimised.

### RELATED APPLICATIONS

This patent application claims priority to Indian patent application serial number 1523/CHE/2007, having title “Storing Data”, filed on 16 Jul. 2007 in India (IN), commonly assigned herewith, and hereby incorporated by reference.

### BACKGROUND OF THE INVENTION

Applications such as compilers and editors create transient files, such as temporary files, during their execution. Due to the nature of these files, such applications can benefit by having the files stored in primary memory, where they can be quickly accessed, rather than having to access them from a disk. Since primary memory accesses are much faster than disk accesses, significant performance gains can be achieved.

There are two conventional ways in which temporary files can be stored in primary memory. A first is to create a RAMdisk (a device driver that uses primary memory as storage). A filesystem can then be built on the RAMdisk, and all filesystem accesses will be from primary memory.

A second approach is to create a memory based filesystem that uses pageable memory to store filesystem data. Since memory based filesystems can occupy a significant portion of the primary memory, the ability to page out the memory filesystem pages is necessary to ensure that other consumers of the available system memory are not affected. Pageable memory can be made available either as allocated virtual memory of a user process or as kernel anonymous memory.

Modern memory based filesystems such as tmpfs, available on Linux, Solaris and NetBSD, make use of kernel anonymous memory to store filesystem data.

Memory based filesystems that are implemented in operating systems where kernel anonymous memory cannot be allocated employ one of two conventional techniques. In a first technique, filesystem data files and metadata are stored in user-process virtual memory, and can be transparently swapped to a swap device when the virtual memory system needs to free memory.

In a second technique, filesystem data and metadata are stored in kernel pages and paging to a separate swap device is performed using a separately implemented paging system.

However, a disadvantage with conventional memory based filesystems that operate using user process virtual memory is that they can result in data files being duplicated, having one copy in the filesystem (the user process virtual memory) and a further copy in buffer cache of the operating system, used to buffer transfers to the filesystem. This is an inefficient usage of the primary memory.

A further disadvantage with storing transient files in user-process virtual memory is that there needs to be a context switch for every read or write of the buffer belonging to the memory filesystem, which affects its performance. This is because operating system kernels cannot page-in data from a user process virtual memory space other than that of a currently running process. A context switch to the user process whose virtual memory is used to store the filesystem is therefore required for each read or write operation.

### BRIEF DESCRIPTION OF DRAWING

FIG. 1 is a schematic illustration of a processing system;

FIG. 2 is a high-level overview of a processing system;

FIG. 3 is a schematic illustration of a memory management system according to the present invention;

FIG. 4 is a flow diagram illustrating the processing steps performed by the memory management system of the present invention; and

FIG. 5 is a schematic illustration of a virtual memory management system according to the present invention.

### DETAILED DESCRIPTION OF THE INVENTION

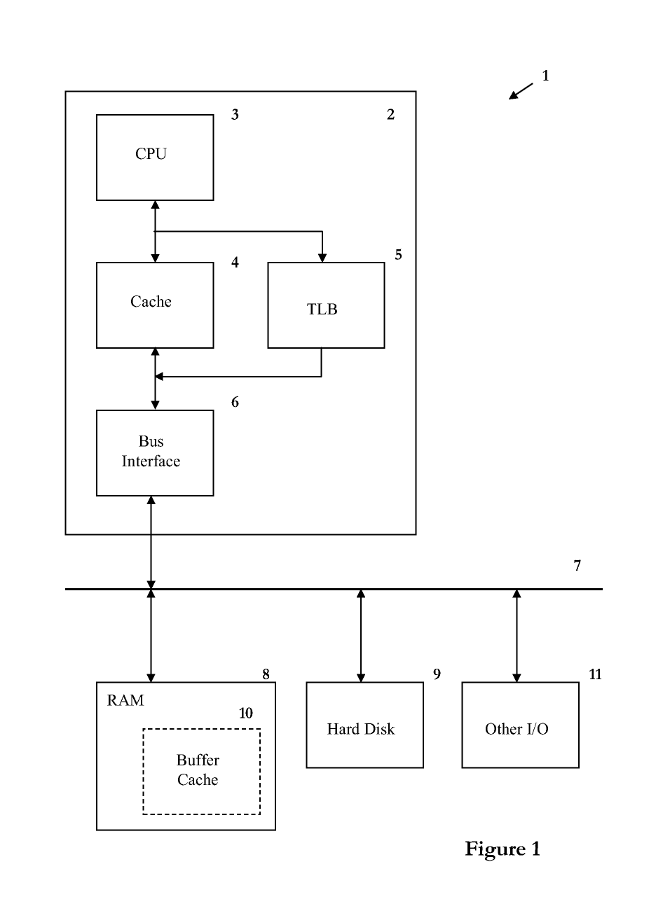

FIG. 1 is a schematic illustration of a processing system 1, such as a server or workstation. The system 1 comprises a processor 2 including a central processing unit CPU 3, an internal cache memory 4, a translation lookaside buffer TLB 5 and a bus interface module 6 for interfacing to a bus 7. Also interfaced to the bus 7 is primary memory 8, also referred to as main or physical memory, in this example random access memory (RAM), and a hard disk 9. The RAM 8 includes a portion allocated as buffer cache 10, used to implement buffers for buffering data being transferred to and from the hard disk 9. The buffer cache typically controls usage of its memory space using one or more free-lists, although alternative implementations can be used. The system typically also includes a variety of other input/output subsystems 11 interfaced to the bus, which are required for the operation of the system.

It should be understood that FIG. 1 is exemplary only and that the invention is not limited to the illustrated system, but could alternatively be applied to more complex systems such as those having multiple processors or operating over a network.

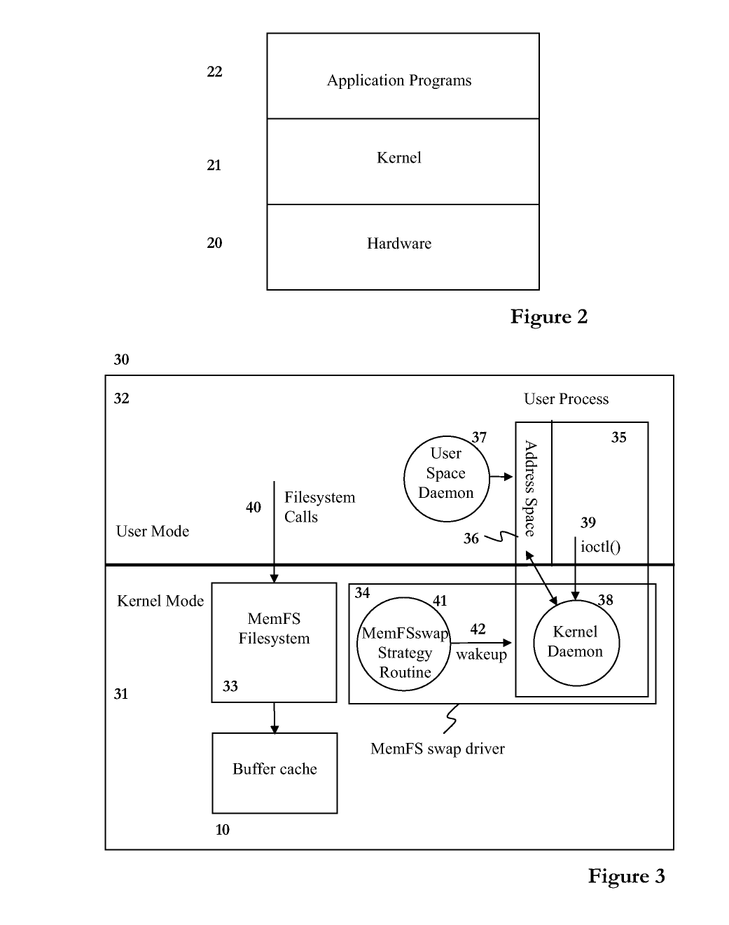

FIG. 2 is a high-level overview of a processing system illustrating the inter-relationship between software and hardware. The system includes hardware 20, a kernel 21 and application programs 22. The hardware is referred to as being at the hardware level of the system and includes the hardware system elements shown in FIG. 1. The kernel 21 is referred to as being at the kernel level and is the part of the operating system that controls the hardware. The application programs 22 running on the processing system are referred to as being at a user level.

The cache memory 4, main memory 8 and hard disk 9 of the processing system 1 shown in FIG. 1 are all capable of storing program instructions and data, generally referred to together as data. Processing of data within these memories is handled by memory management systems, which conventionally operate at the kernel level.

Referring to FIG. 3, a memory management system 30 of a processing system according to the present invention is schematically illustrated. The memory management system 30 operates in the kernel mode 31 of an operating system, or at the kernel level, as well as in the user mode 32 of the operating system, or at the user level. In the kernel mode 31, a kernel filesystem component 33 is provided, in this case the MemFS filesystem component of the HP-UX Unix-based operating system, which performs operations on the buffer cache 10 of the processing system. A MemFS swap driver 34 runs at the kernel level 31 and a user process 35, having an allocated address space 36, runs at the user level 32. A user space daemon 37 and a kernel daemon 38 are implemented in the user mode 32 and kernel mode 31 respectively. These are processes that run in the background of the operating system, rather than being under the direct control of the user, and perform memory management tasks when required, as explained in detail below.

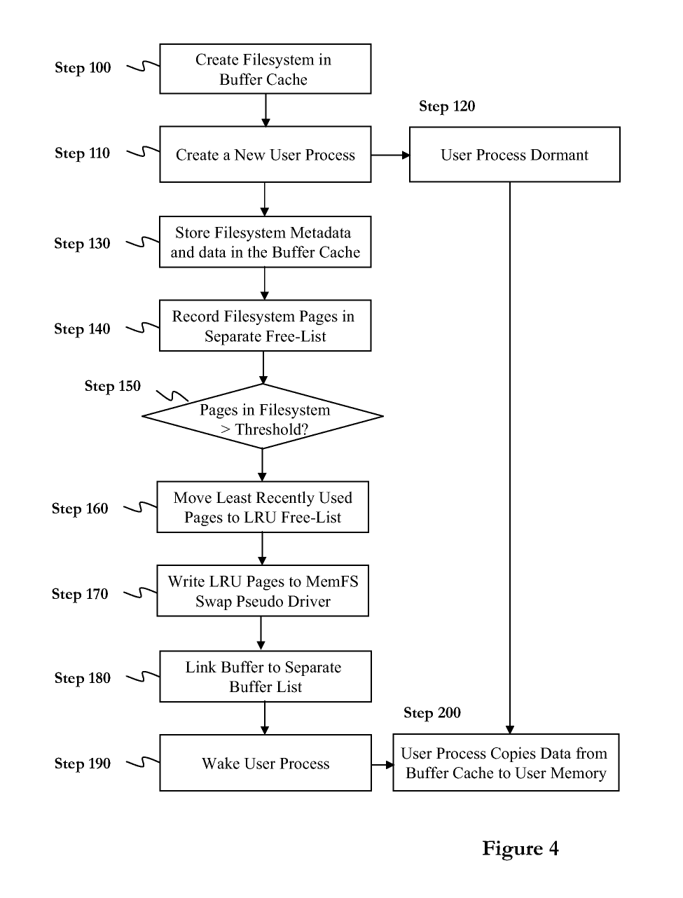

Operation of the memory management system 30 will now be described with reference to FIG. 4.

The kernel filesystem component 33, namely the MemFS filesystem, is implemented to create a filesystem in the buffer cache 10 (step 100). In the present example, this is performed by a mount system call of the Unix mount command line utility, for instance invoked by a user. Having created the filesystem in the buffer cache 10, the mount utility forks a new user process 35 (step 110), whose user process memory can be used to hold temporary files. In the present example, the user process 35 makes an ioctl call 39 to the MemFS swap driver 34 and, while in the ioctl function, continues running as the kernel daemon 38 in the background that will sleep, waiting for input/output requests in the ioctl function (step 120). A flag is set at mount time, when the ioctl function is called, and as long as this flag is set the ioctl routine will loop and will not terminate. The flag is, for instance, stored in a structure that is associated with every mount instance. The Berkeley Software Distribution (BSD) memory file system (MFS) has an I/O servicing loop in the mount routine of the filesystem, rather than in an ioctl of a driver, and therefore implementations using the BSD MFS would be adapted accordingly.

Once the memory filesystem has been mounted, data and metadata to be written to the filesystem will be stored in the buffer cache 10 using filesystem calls 40 from the user mode 32. All accesses to the MemFS filesystem will go through the buffer cache 10. Metadata in this context comprises file attribute information, in the present example stored in the form of an inode for each datafile, as well as a superblock and a collection of cylinder groups for the filesystem. To prevent pages of the filesystem data and metadata from being stolen by other processes, buffer allocations for the filesystem are recorded in a separate MemFS free list to the standard buffer free-list of the buffer cache 10 (step 140).

When the number of pages in the memory filesystem exceed a predetermined threshold (step 150), least recently used pages are no longer recorded in the MemFS free list and are instead moved to the least recently used free list (LRU free list) of the buffer cache 10 (step 160). The threshold is, in the present example, implemented as a system kernel tunable defined as a percentage of the largest memory size that the buffer cache 10 can occupy. A count of the number of MemFS buffers in the buffer cache 10 can be monitored in relation to this threshold every time a buffer is assigned.

Pages recorded in the LRU free list are written, using the bwrite interface, to the MemFS swap pseudo driver 34 (step 170). The strategy routine 41 (see FIG. 3) of the MemFS swap pseudo driver 34 will service the request by linking the filesystem buffer onto a separate buffer list (step 180), the list recording all pending buffers that need to be copied to the memory of the user process 35. The strategy routine 41 will also send a wake-up 42 to the user process daemon, in the present example using a standard UNIX sleep/wakeup mechanism (step 190). The user process, when awoken, will receive data from the buffer cache filesystem buffer, the data being transferred by the MemFS swap pseudo driver 34 to the user process memory of the user process 35 (step 200). Only data buffers are transferred from the buffer cache 10 to the user process address space 35. This ensures that metadata remains in the buffer cache 10 and accordingly that operations which involve only metadata will always be fast.

The amount of RAM 8 is limited and if all the data associated with a particular program, such as the user process 35, is made available in the RAM 8 at all times, the system could only run a limited number of programs. Modern operating systems such as HP-UX™ therefore operate a virtual memory management system, which allows the kernel 21 to move data and instructions to the hard disk 9 or external memory devices from the RAM 8 when the data is not required, and to move it back when needed. The total memory available is referred to as a virtual memory and can therefore exceed the size of the physical memory. Some of the virtual memory space has corresponding addresses in the physical memory. The rest of the virtual memory space maps onto addresses on the hard disk 9 and/or external memory device. Hereinafter, any reference to loading data from the hard disk into RAM 8 should also be construed to refer to loading data from any other external memory device into RAM 8, unless otherwise stated.

When the user process 35 is compiled, the compiler generates virtual addresses for the program code that represent locations in memory. Once the data from the buffer cache 10 has been transferred from the buffer cache 10 to the address space of the user process 35, the data will accordingly be controlled by the virtual memory management system of the operating system. If there is not enough available memory in the physical memory 8, used memory has to be freed and the data and instructions saved at the addresses to be freed are moved to the hard disk 9. Usually, the data that is moved from the physical memory is data that has not been used for a while.

When the operating system then tries to access the virtual addresses while running a program such as the user process 35, the system checks whether a particular address corresponds to a physical address. If it does, it accesses the data at the corresponding physical address. If the virtual address does not correspond to a physical address, the system retrieves the data from the hard disk 9 and moves the data into the physical memory 8. It then accesses the data in the physical memory 8 in the normal way.

A page is the smallest unit of physical memory that can be mapped to a virtual address. For example, on the HP-UX™ system, the page size is 4 KB. Virtual pages are therefore referred to by a virtual page number VPN, while physical pages are referred to by a physical page number PPN. The process of bringing virtual memory into main memory only as needed is referred to as demand paging.

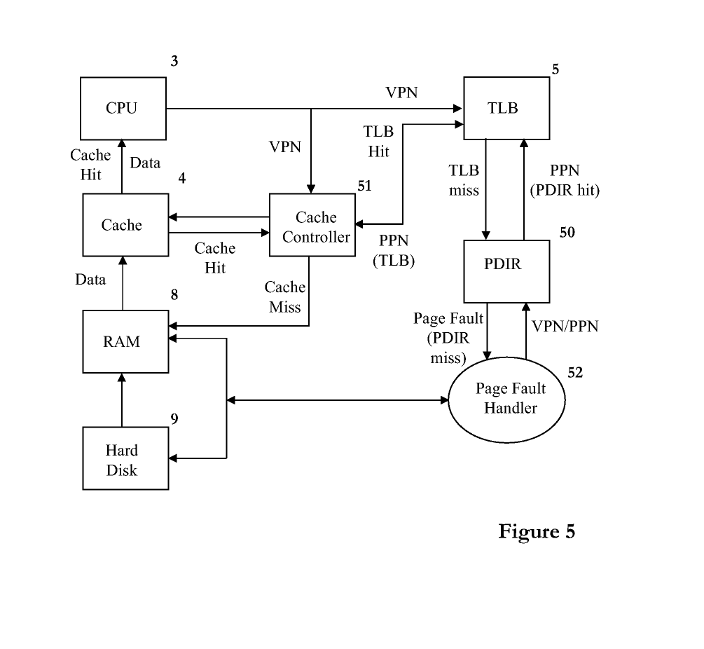

Operation of a virtual memory management system will be described with reference to FIG. 5. To manage the various kinds of memory and where the data is stored, an operating system, such as HP-UX™ maintains a table in memory called the Page Directory (PDIR) 50 that keeps track of all pages currently in memory. When a page is mapped in some virtual address space, it is allocated an entry in the PDIR 50. The PDIR 50 is what links a physical page in memory to its virtual address.

The PDIR 50 is saved in RAM 8. To speed up the system, a subset of the PDIR 50 is stored in the TLB 5 in the processor 2. The TLB 5 translates virtual to physical addresses. Therefore, each entry contains both the virtual page number and the physical page number.

When the CPU 3 wishes to access a memory page, it first looks in the TLB 5 using the VPN as an index. If a physical page number PPN is found in the TLB 5, which is referred to as a TLB hit, the processor knows that the required page is in the main memory 8. The required data from the page can then be loaded into the cache 4 to be used by the CPU 3. A cache controller 51 may control the process of loading the required data into memory. The cache controller 51 will check whether the page already exist in memory. If not, the cache controller 51 can retrieve the data from the RAM 8 and move it into the cache 4.

If the page number is not found in the TLB 5, which is referred to as a TLB miss, the PDIR 50 is checked to see if the required page exists there. If it does, which is referred to as a PDIR hit, the physical page number is loaded into the TLB 5 and the instruction to access the page by the CPU 3 is restarted again. If it does not exist, which is generally referred to as a PDIR miss, this indicates that the required page does not exist in physical memory 8, and needs to be brought into memory from the hard disk 9 or from an external device. The process of bringing a page from the hard disk 9 into the main memory 8 is dealt with by a software page fault handler 52 and causes corresponding VPN/PPN entries to be made in the PDIR 50 and TLB 5, as is well known in the art. When the relevant page has been loaded into physical memory 8, the access routine by the CPU 3 is restarted and the relevant data can be loaded into the cache 4 and used by the CPU 3.

In the present example, the user space daemon 37 is used to determine which of the pages allocated to the user process 35 should be wired. A wired page is one that permanently resides in the PDIR 50 and is therefore not paged out to the hard disk 9. Command interfaces can be created to wire specific pages in the PDIR 50.

After the filesystem has been unmounted using the MemFS command line utility, a MemFS swap driver close routine (not illustrated) will be called. This will flush any pending I/O requests and clear the flag of the ioctl routine called by the unmount command that was set at the time the filesystem was mounted, such that the ioctl routine can terminate its I/O servicing loop, which provides an indication that the filesystem is unmounted.

The memory management system 30 of the present invention may be implemented as computer program code stored on a computer readable medium. The program code can, for instance, provide a utility for implementing the memory filesystem in the buffer cache 10, for instance the MemFS filesystem utility 33 according to the Unix architecture. The program code can also provide the MemFS swap driver implemented for transferring data from the buffer cache 10 to the user process virtual memory 36 as previously described, as well as other components of the memory management system 30, as would be understood by the person skilled in the art.

1. A method of storing data in a computing device, the method comprising:
creating a memory file system in non-pageable kernel memory of the computing device;
writing data to the memory file system; and
transferring the written data to a pageable memory space allocated to a user process running on the computing device.

2. A method according to claim 1, further comprising writing metadata to the file system and wherein the step of transferring the written data comprises transferring data other than the metadata.

3. A method according to claim 2, wherein the metadata comprises superblock, cylinder group or inode data.

4. A method according to claim 1, further comprising:
generating the user process and assigning the pageable memory space to the user process.

5. A method according to claim 1, wherein creating a memory file system comprises creating a UNIX file system in memory occupied by buffer cache.

6. A method according to claim 1, wherein creating a memory file system comprises creating a UNIX file system using an MemFS mount command.

7. A method according to claim 5, further comprising maintaining usage data relating to the memory file system separate from the usage data of other portions of the buffer cache memory.

8. A method according to claim 1, further comprising maintaining a mapping of data files of the memory file system that have been transferred to the pageable memory space.

9. A method according to claim 1, further comprising transferring the written data to the pageable memory space in response to data stored in the file system reaching a predetermined threshold.

10. A method according to claim 1, wherein transferring the written data to the pageable memory space is performed when the data comprises one of a plurality of least recently used pages in the file system.

11. A method according to claim 1, further comprising preventing paging of the data once it has been transferred to the pageable memory space.

12. A method according to claim 1, further comprising removing the memory file system from the non-pageable kernel memory.

13. A method according to claim 1, wherein the data comprises temporary file data.

14. A buffer cache for a computing device, the buffer cache comprising:
a first portion arranged for use as buffer cache memory;
a second portion implemented for storing a memory file system; and
separate usage data for each of the first and second portions.

15. A computer readable medium storing program code for implementing a memory management system in a computing device when executed by a processor associated with the computing device, the program code comprising:
first program instructions which, when executed, provide a utility for creating a memory file system in non-pageable kernel memory associated with the computing device; and
second program instructions which, when executed, provide a process for transferring the data in the memory file system to a pageable memory space allocated to a user process running on the computing device.

16. A computer readable medium according to claim 15, wherein the first program instructions, when executed, provide a utility for creating a UNIX file system in memory of the computing device occupied by buffer cache.

17. A computer readable medium according to claim 15, wherein the second program instructions, when executed, provide a process for transferring the data in the memory file system to the pageable memory space in response to data stored in the file system reaching a predetermined threshold.

18. A computer readable medium according to claim 15, wherein the second program instructions, when executed, provide a process for transferring the data in the memory file system to the pageable memory space when the data comprises one of a plurality of least recently used pages in the file system.

19. A computer readable medium according to claim 15, storing program code further comprising third program instructions which, when executed, provide a process for preventing paging of the data once it has been transferred to the pageable memory space.

20. A computer readable medium according to claim 15, storing program code further comprising third program instructions which, when executed, implement a buffer cache having a first portion arranged for use as buffer cache memory, a second portion implemented for storing a memory file system, and separate respective usage data for each of the first and second portions.
